(19) United States
(12) Patent Application Publication
(10) Pub. No.: US 2025/0327254 A1
(43) Pub. Date: Oct. 23, 2025

(54) PDC GRINDING TIP AND WHEEL FOR PAVEMENT GRINDING

(71) Applicant: GENERAL TOOL, INC., Irvine, CA (US)

(72) Inventors: Jae Yong Ohm, Irvine, CA (US); Tae Min Um, Irvine, CA (US); Jae Woo Kim, Irvine, CA (US)

(73) Assignee: GENERAL TOOL, INC., Irvine, CA (US)

(21) Appl. No.: 19/183,592

(22) Filed: Apr. 18, 2025

Related U.S. Application Data
(60) Provisional application No. 63/635,913, filed on Apr. 18, 2024.

(51) Int. Cl. E01C 23/088; B02C 18/18; E01C 23/09; E01C 23/12

(52) U.S. Cl. CPC E01C 23/088; B02C 18/18; E01C 23/09; E01C 23/127

(57) ABSTRACT

The present invention provides a grinding wheel product which removes various construction materials such as concrete, asphalt, thermoplastic, traffic markings, lines or signal on the street or highway through rotating motion.

### CROSS REFERENCE TO RELATED APPLICATIONS

This non-provisional application claims the benefit under 35 U.S.C. § 119(e) to U.S. Provisional Application No. 63/635,913, filed on Apr. 18, 2024, all of which are hereby expressly incorporated by reference into the present application.

### FIELD OF THE INVENTION

The disclosed invention relates to the means of pavement grooving, grinding and material removal. More specifically, the invention relates to a product which removes various construction materials such as concrete, asphalt, thermoplastic, traffic markings, lines or signals on the street or highway through rotating motion.

### BACKGROUND OF THE INVENTION

Pavement grooving and grinding has been consistently in a high demand due to various reasons such as government infrastructure projects and maintenance or sensor for autonomous vehicles. Diamond blades have been used as predominant grooving tools in the field for such purposes. However, diamond blades have relatively low feed rate and short lifespans, which are two common factors directly related to the cost savings.

Nowadays different tools are used in the field with polycrystalline diamond compact (PDC) tooling. PDC tooling overcomes the drawbacks of diamond blades, and it has become a predominant method of pavement grooving and for grinding jobs. Especially for grooving, there are strict requirements such as depth and shape. To fulfill the requirements, two different types of PDC segments are used. One is designed with a single PDC attached to a body of steel, and another one is designed with two PDCs attached to a body of steel. The PDCs are then mounted on a steel plate.

The grooving environment is a harsh one, with high impact loading on the PDC tips. Repeated impact loading on the PDC tips can cause the initiation of fatigue cracks on PDC and, for the worst case, the damaged tips are broken and fallen apart from the body of steel. In one embodiment of the invention, a piece with single PDC segment attached is exposed to such an environment.

### SUMMARY OF THE INVENTION

The invention utilizes polycrystalline diamond compact (PDC) to increases the longevity of the tool while in use. A double chamfer added to the surface of PDC tip with laser cutting machine further increases the longevity of the tool by enhancing impact resistance of PDC and a PDC segment as a whole. Modified PDC is then strongly attached to the body of steel through the method of high frequency brazing.

The invention ultimately provides higher feed rate than diamond blades or PDC products and provides simplicity during mounting and unmounting procedures. Other features and advantages of the invention become more evident with the following detailed description in conjunction with the accompanied drawings.

### BRIEF DESCRIPTION OF THE DRAWINGS

FIGS. 1, 2, and 3 are isometric views of a grinding element of the invention having a single PDC segment;

FIGS. 4, 5, and 6 are isometric views of grinding element of the invention having a double PDC segment;

FIGS. 7, 8, and 9 are exploded isometric views of the single and double PDC segments attached together;

FIGS. 10, 11, and 12 are isometric views of an alternative embodiment of a grinding element;

FIG. 13 is a side view of a steel plate that the set of the PDC segments mounts on;

FIG. 14 is a top view of the steel plate;

FIG. 15 is an exploded isometric view of set of a single and a double PDC segments and a steel plate;

FIG. 16 is an isometric view of the set of PDC segments attached to the steel plate; and

FIG. 17 is a partial view of several hubs attached in an axial direction of the hubs.

### DETAILED DESCRIPTION OF THE INVENTION

The grinding wheel includes a hub with detachable grinding elements. The grinding elements are formed by carriers supporting and retaining at least one PDC segment. A plurality of hubs can be stacked to form a grinding wheel of any desired thickness. The grinding elements can be attached to the hub with any suitable fastener, such as a bolt.

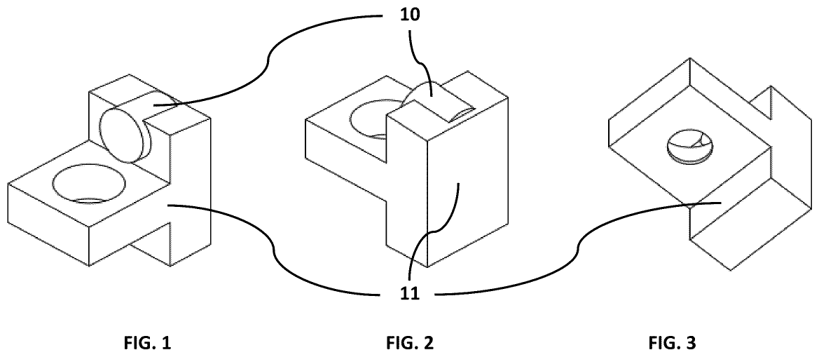

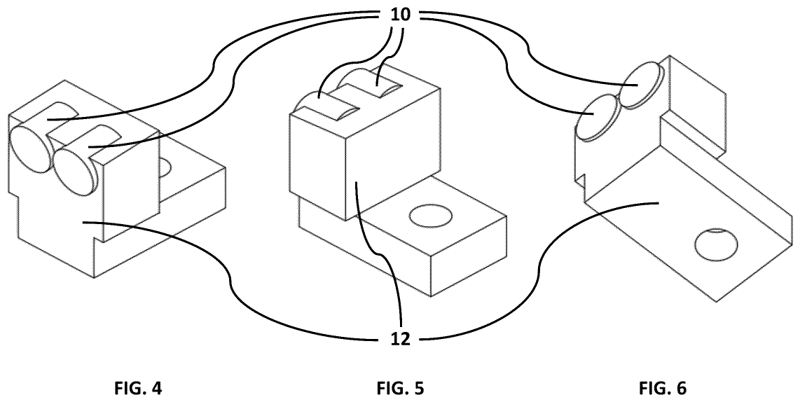

As shown in FIGS. 1, 2 and 3, a T-shaped carrier 11 has a vertical section retaining a single PDC segment 10 and a horizontal section having a threaded hole. The PDC segment 10 is retained in a groove in a top surface of the carrier so that a leading edge of the PDC segment 10 extends passed the edge of the horizontal section. As can be seen in FIG. 2, the groove retaining the PDC segment 10 does not extend an entire length of the top surface, so that the trailing edge of the PDC segment 10 is supported by the carrier. This provides structural integrity and prevents the PDC segment 10 from moving relative to the carrier when grinding.

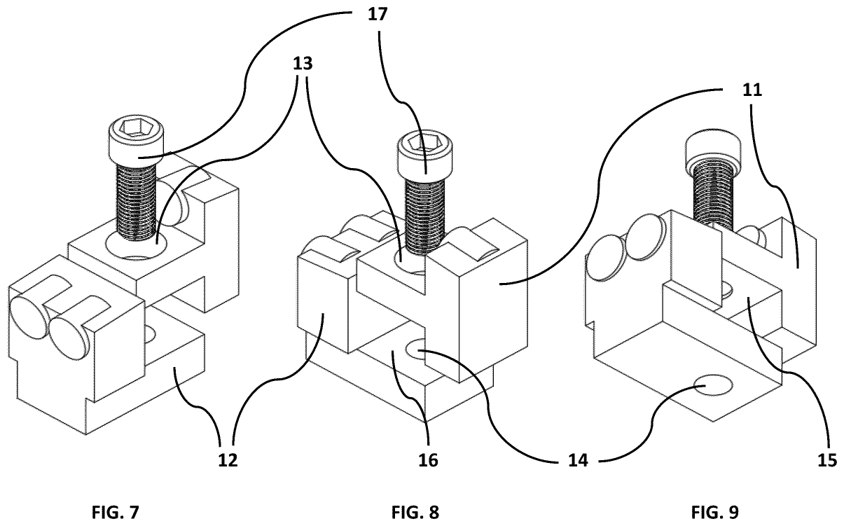

FIGS. 4, 5, and 6, depict an L-shaped carrier with a vertical section retaining two PDC segments 10 and a horizontal section having a threaded hole. The PDC segments 10 are retained in two grooves in a top surface of the carrier. Similar to the T-shaped carrier, leading edges of the PDC segments 10 extend passed the edge of the horizontal section.

As shown in FIGS. 7, 8, and 9, the T-shaped single carrier and L-shaped double carrier are joined together by having the respective horizontal sections overlapped and connected with a threaded fastener. The threaded screw 17 passes through a hole 13 of the single PDC segment 11 which is located at the top of the surface 16 of the double PDC segment 12 and a hole 14 of the double PDC segment 12 which is located at the bottom of the surface 15 of the single PDC segment 11.

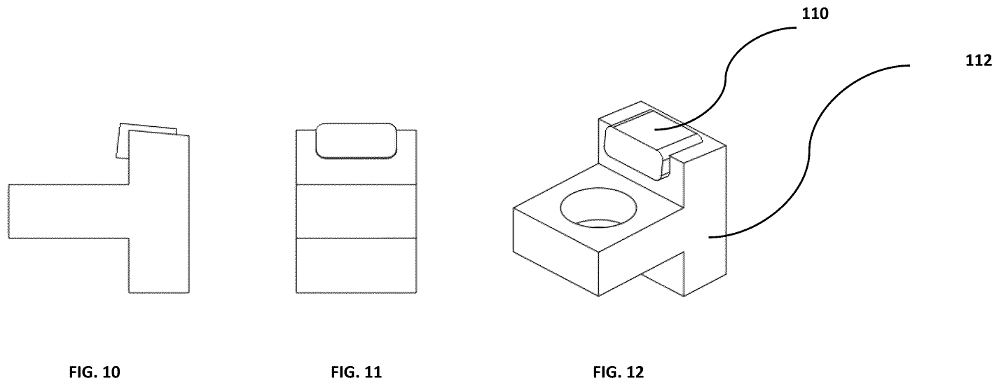

An alternative grinding element is shown in FIGS. 10, 11 and 12. The T-shaped carrier 112 retains a PDC segment 110 having an oval cross section. In this case, only a single carrier may be required, as the PDC segment 110 is elongated in the axial direction to provide a wider cutting surface. Other shapes of the PDC segment are possible, such as elliptical and rectangular.

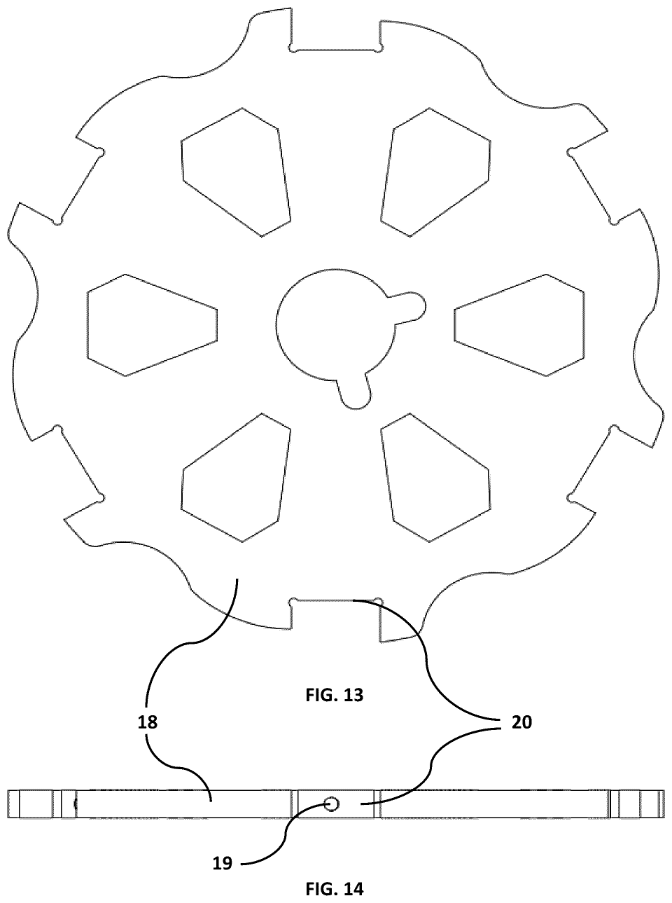

The carrier set is secured to a hub, preferable with the same fastener that joins the single carrier and double carrier. A hub is seen in FIGS. 13 and 14. A plurality of slots 20 are spaced about the circumference of the hub. There are six slots 20 on a hub 18 shown in FIG. 13 but any number of slots can be used, depending on the size of the hub and other factors. As shown on FIG. 14, for each slot 20, there is a threaded hole 19 located in the middle of the slot.

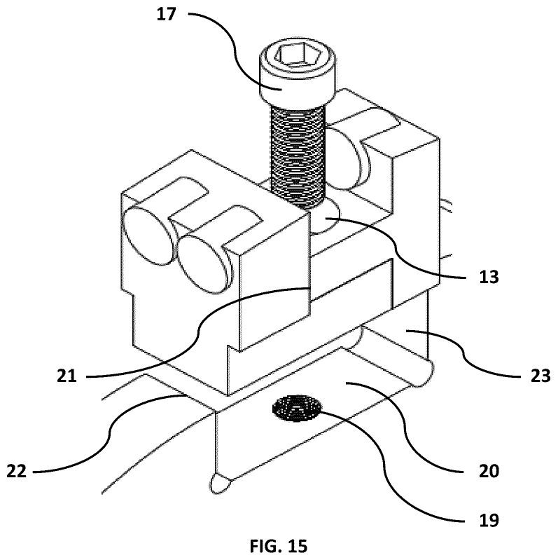

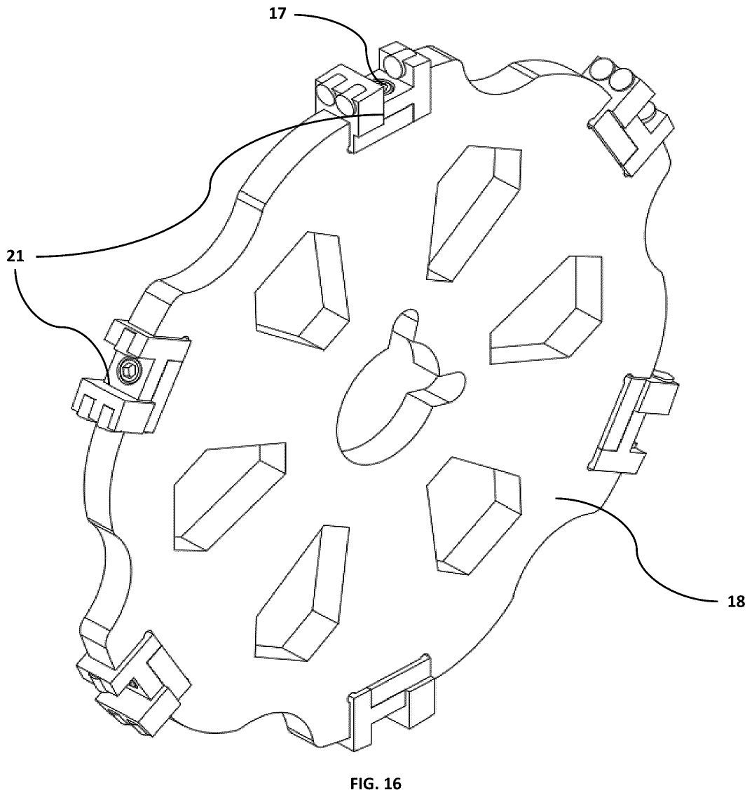

Each set of PDC segments 21 is place above the slot 20 between a front surface 22 of the slot, wherein a front surface of the double PDC segment 12 contacts, and a rear surface 23 of the slot, where rear surface of the single PDC segment 11 contacts. A fastener, such as threaded bolt 17, extends into threaded hole 19 on the hub 18 to simultaneously connect the T-shaped single carrier and L-shaped double carrier together and secure the carriers to the hub, as shown in FIG. 15. As shown in FIG. 16, a total of six sets of PDC segments 21 and threaded screws 17 are fully assembled with the steel plate 18.

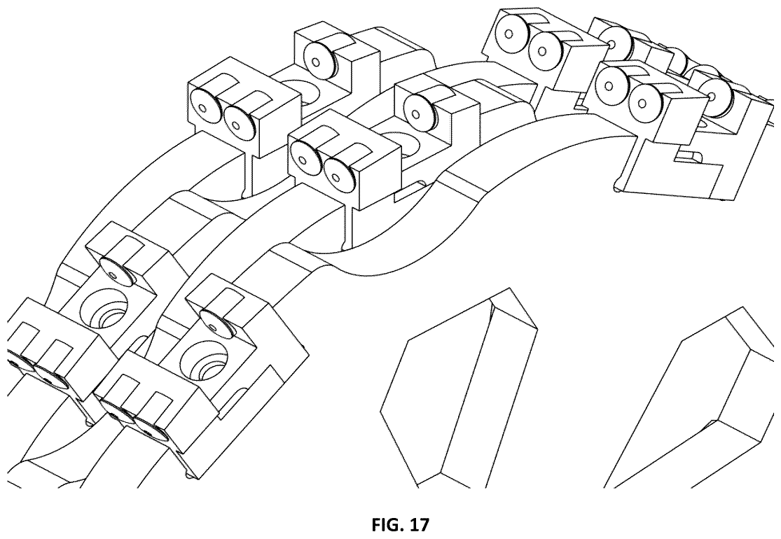

FIG. 17 depicts several hubs joined together in an axial direction. As seen in FIG. 17, a width of the carriers in the axial direction is greater than a width of the hub. The carriers of alternate hubs are offset from each other in the circumferential direction to avoid interference between carriers in adjacent hubs.

The invention being thus described, it will be apparent to one of ordinary skill in the art that various modifications of the materials and methods for practicing the invention can be made. Such modifications are to be considered within the scope of the invention as defined by the following claims.

We claim:

1. A grinding wheel, comprising:
a hub;
a plurality of teeth removably attached to a circumference of the hub, wherein each of the teeth comprises:
a carrier;
at least one polycrystalline diamond compact (PDC) segment extending beyond a leading edge of the carrier.

2. The grinding wheel of claim 1, further comprising a plurality of recesses on the circumference of the hub,
wherein each of the plurality of teeth fits within a respective one of the plurality of recesses.

3. The grinding wheel of claim 1, further comprising a groove in the carrier, a length of the groove being less than a length of a top of the carrier, the groove extending to a top surface of the carrier.

4. The grinding wheel of claim 1, further comprising a groove in the carrier, the groove extending to a top surface of the carrier, and
wherein a width of the groove at the top surface of the carrier is less than a diameter of the cylinder.

5. The grinding wheel of claim 4, wherein the cylinder extends above a top surface of the carrier.

6. The grinding wheel of claim 1, wherein the carrier comprises:
a first carrier and a second carrier, and
wherein a fastener extends through the first carrier and second carrier and into the hub.

7. The grinding wheel of claim 6, wherein the first carrier is L-shaped and the second carrier is T-shaped.

8. The grinding wheel of claim 1, wherein said wheel comprises a plurality of said PDC segments.

9. The grinding wheel of claim 1, wherein said PDC segments are oval, cylindrical, elliptical or rectangular in cross-section.

10. The grinding wheel of claim 1, wherein said PDC segments are oval in cross-section.

11. The grinding wheel of claim 1, which comprises six of said PDC segments.
